(19) United States
(12) Patent Application Publication
(10) Pub. No.: US 2021/0005331 A1
(43) Pub. Date: Jan. 7, 2021

(54) MANAGEMENT DEVICE, MANAGEMENT METHOD, AND PROGRAM

(71) Applicant: YOKOGAWA ELECTRIC CORPORATION, Tokyo (JP)

(72) Inventor: Keisuke SAWADA, Tokyo (JP)

(21) Appl. No.: 17/023,422

(22) Filed: Sep. 17, 2020

Related U.S. Application Data
(63) Continuation of application No. PCT/JP2019/017425, filed on Apr. 24, 2019.

(30) Foreign Application Priority Data
Apr. 27, 2018 (JP) 2018-087175

(51) Int. Cl. G16Y 40/35; G06K 7/14; G16Y 20/10; G16Y 30/00; H04L 29/08

(52) U.S. Cl. CPC G16Y 40/35; G06K 7/1434; H04L 67/12; G16Y 30/00; G16Y 20/10

(57) ABSTRACT

Provided is a management device comprising a device information storage section that stores sense data identification information identifying sense data output by each of a plurality of sensor apparatuses that communicate via a network, in association with the each sensor apparatus; a data storage section that stores the sense data received from each of the plurality of sensor apparatuses in association with the sense data identification information associated with the each sensor apparatus in the device information storage section; and a replacement processing section that, in response to a first sensor apparatus among the plurality of sensor apparatuses being replaced with a second sensor apparatus, sets first sense data identification information associated with the first sensor apparatus in the device information storage section to be second sense data identification information associated with the second sensor apparatus.

### CROSS REFERENCE TO RELATED APPLICATION

This is a continuation application of International Application No. PCT/JP2019/017425, filed on Apr. 24, 2019, which claims priority to Japanese Patent Application No. 2018-087175, filed on Apr. 27, 2018, the contents of each of which are incorporated herein by reference.

### BACKGROUND

### 1. Technical Field

The present invention relates to a management device, a management method, and a program.

### 2 Related Art

Conventionally, a plant or the like is controlled using a DCS (Distributed Control System) that includes field devices such as sensor apparatuses and actuators installed in various parts of the plant and a control apparatus for controlling these devices. Furthermore, in various fields other than the industrial field as well, systems are used in which a large number of sensors or the like are arranged in a distributed manner to perform measurement, monitoring, and the like. In recent years, focus has been placed on the Internet of things (IoT) and the industrial Internet of things (Hot), and progress has been made for providing the cloud for systems such as described above. Patent Literature 1 discloses a system and a method relating to the use of cloud computing in industrial applications.
Patent Literature 1: Japanese Unexamined Patent Application Publication No. 2012-523038.

### SUMMARY

Since the sense data is associated with the device identification information of a sensor apparatus in the conventional system, it is impossible to preserve the continuity of the sense data when a sensor apparatus is replaced.

According to a first aspect of the present invention, provided is a management device. The management device may comprise a device information storage section that stores sense data identification information identifying sense data output by each of a plurality of sensor apparatuses that communicate via a network, in association with the each sensor apparatus. The management device may comprise a data storage section that stores the sense data received from each of the plurality of sensor apparatuses in association with the sense data identification information associated with the each sensor apparatus in the device information storage section. The management device may comprise a replacement processing section that, in response to a first sensor apparatus among the plurality of sensor apparatuses being replaced with a second sensor apparatus, sets first sense data identification information associated with the first sensor apparatus in the device information storage section to be second sense data identification information associated with the second sensor apparatus.

According to a second aspect of the present invention, provided is a management method. The management method may comprise storing, in a device information storage region, sense data identification information identifying sense data output by each of a plurality of sensor apparatuses that communicate via a network, in association with the each sensor apparatus. The management method may comprise storing, in a data storage region, the sense data received from each of the plurality of sensor apparatuses in association with the sense data identification information associated with the each sensor apparatus in the device information storage region. The management method may comprise, in response to a first sensor apparatus among the plurality of sensor apparatuses being replaced with a second sensor apparatus, setting first sense data identification information associated with the first sensor apparatus in the device information storage region to be second sense data identification information associated with the second sensor apparatus

According to a third aspect of the present invention, provided is a program. The program may cause a computer to function as a device information storage section that stores sense data identification information identifying sense data output by each of a plurality of sensor apparatuses that communicate via a network, in association with the each sensor apparatus. The program may cause the computer to function as a data storage section that stores the sense data received from each of the plurality of sensor apparatuses in association with the sense data identification information associated with the each sensor apparatus in the device information storage section. The program may cause the computer to function as a replacement processing section that, in response to a first sensor apparatus among the plurality of sensor apparatuses being replaced with a second sensor apparatus, sets first sense data identification information associated with the first sensor apparatus in the device information storage section to be second sense data identification information associated with the second sensor apparatus.

The summary clause does not necessarily describe all necessary features of the embodiments of the present invention. The present invention may also be a sub-combination of the features described above.

### BRIEF DESCRIPTION OF DRAWINGS

FIG. 1 shows a device provisioning environment 10 according to the present embodiment.

FIG. 2 shows a sensor apparatus 200, which is an example of the network device 100 according to the present embodiment.

FIG. 3 shows a sensor gateway apparatus 300 that is an example of the network device 100 according to the present embodiment.

FIG. 4 shows configurations of the provisioning system 120 and the terminal 130 according to the present embodiment.

FIG. 5 shows configurations of the provisioning system 120 and the terminal 130 according to the present embodiment.

FIG. 6 shows configurations of the provisioning system 140 and the terminal 150 according to the present embodiment.

FIG. 7 shows a process flow of the terminal 150, the network device 100, the provisioning system 140, and the base system 160 according to the present embodiment.

FIG. 8 shows a configuration of the base system 160 according to the present embodiment.

FIG. 9 shows the data storage section 850 according to the present embodiment.

FIG. 10 shows the device management DB 820 according to the present embodiment.

FIG. 11 shows a process flow of the base system 160 according to the present embodiment.

FIG. 12 shows a process flow of the terminal 150, the provisioning system 140, and the base system 160 in a case where a first sensor apparatus 200 is replaced with a second sensor apparatus 200.

FIG. 13 shows an example of a computer 2200 according to the present embodiment.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

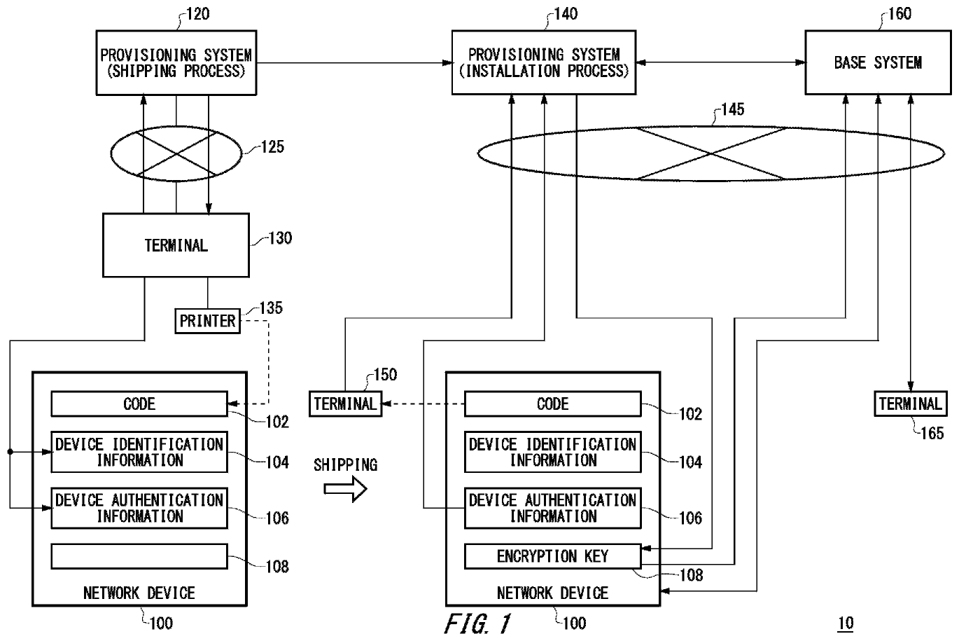

FIG. 1 shows a device provisioning environment 10 according to the present embodiment. In the present embodiment, the device provisioning environment 10 includes a provisioning system 120 that performs pre-shipment setting of a network device 100 and a provisioning system 140 that performs setting of the network device 100 during installation, and makes it possible for the network device 100 to be easily and securely connected to a base system 160, which is a cloud computer, fog computer, or the like (referred to below as a “cloud computer or the like).

The device provisioning environment 10 includes a provisioning system 120, a network 125, a terminal 130, and a printer 135 for performing pre-shipment setting and preparation of the network device 100; a provisioning system 140 and a terminal 150 for performing installation settings of the network device 100 that has reached the user; and a base system 160 and a terminal 165 for constructing a cloud computing system or fog computing system (referred to below as a “cloud computing system or the like”) that performs monitoring, control, and the like of one or more of the network devices 100.

The network device 100 is a field device, sensor, or the like connectable to a network 145 such as any one of the Internet, a wide area network, a local area network, and a mobile network, or is a gateway, hub, or the like provided between the network 145 and such a device. The network device 100 may be configured to include an interface module connectable to the network 145 and an application module connected in a replaceable manner to this interface module. The application module may be a sensor module, an actuator module, a relay module that performs input and output, or the like, for example. The network device 100 includes a code label 102 on which is printed a code, provided by the provisioning system 120, that includes device identification information unique to the delivery target network device 100; an identification information storage region 104 for storing the device identification information; an authentication information storage region 106 for storing device authentication information, provided by the provisioning system 120, for authenticating the delivery target network device 100 that is connected to the network 145 at a delivery destination; and an encryption key storage region 108 for storing an encryption key for connecting the delivery target network device 100 to the base system 160.

The provisioning system 120 is a computer system for providing a provisioning service enabling the delivery target network device 100 to be easily and securely connected to the base system 160, by pre-setting the delivery target network device 100 before delivery of the delivery target network device 100 to be connected to the network 125 at the delivery destination. The provisioning system 120 is operated by a service agent who provides this provisioning service. The provisioning system 120 may be a cloud computing system or the like, and may be realized by one or more server computers or the like. In the present embodiment, the service agent is different from the provider (or vendor), such as the manufacturer or seller, of the network device 100. Instead, the service agent may be the same as the provider of the network device 100. Furthermore, the service agent may be the same as or different from a service agent who provides a service realized by the base system 160. The base system 160 according to the present embodiment provides an account that is unique for each provider, in order to provide the provisioning service for the network devices 100 manufactured or sold by a plurality of providers.

The provisioning system 120 provides a service for, in response to a request from the terminal 130 of the provider of the delivery target network device 100 to be connected to the network 145 at the delivery destination, setting unique device identification information enabling the base system 160 to identify the delivery target network device 100, device authentication information for authenticating the delivery target network device 100 connected to the network at the delivery destination, and other necessary information in the delivery target network device 100 before delivery of the delivery target network device 100.

The network 125 provides a wired or wireless connection between the provisioning system 120 and the terminal 130. The network 125 may be the Internet, a wide area network, a local area network, or the like, and may include a mobile network.

The terminal 130 is a terminal used by a provider of the delivery target network device 100, and functions as a setting apparatus of the delivery target network device 100. The terminal 130 may be a computer such as a PC (personal computer), a tablet computer, a smart phone, a work station, a server computer, a general purpose computer, or the like, or may be a computer system in which a plurality of computers are connected. The terminal 130 is used to utilize the provisioning service provided by the provisioning system 120, and sets the device identification information and device authentication information provided by the provisioning system 120 in the identification information storage region 104 and the authentication information storage region 106 of the delivery target network device 100.

The printer 135 is connected to the terminal 130 with a wired or wireless connection, and prints the code including the device identification information onto a sticker or the like, for example, in response to instructions from the terminal 130. In the present embodiment, the code label 102 including the printed code is affixed to the delivery target network device 100.

The provisioning system 140 is a computer system belonging to the service agent who provides the provisioning service for connecting the network device 100 easily and securely to the base system 160. The provisioning system 140 may be a cloud computing system or the like, and may be realized by one or more server computers or the like. In the present embodiment, the service agent that provides the service realized by the provisioning system 120 (service agent of the shipping provisioning service) and the service agent that provides the service realized by the provisioning system 140 (service agent of the installation provisioning service) are the same, and are also different from the provider of the network device 100. Instead, these service agents and the provider of the network device 100 may be the same, or the service agent of the shipping provisioning service may be different from the service agent of the installation provisioning service. The provisioning system 140 according to the present invention provides a unique account to each of a plurality of tenants (companies, departments within companies, or other groups) that purchase and use the network device 100.

The provisioning system 140 receives from the terminal 150 an activation request of a setter who sets the delivery target network device 100 at the delivery destination, and authenticates the delivery target network device 100 connected to the network 145 at the delivery destination using the device authentication information. Then, on a condition that the authentication was successful, the provisioning system 140 registers the network device 100 with the service provided by the base system 160, and provides the delivery target network device 100 with the encryption key for connecting to the base system 160. The encryption key provided by the provisioning system 140 is stored in the encryption key storage region 108 within the network device 100.

The network 145 provides a wired or wireless connection between the network device 100, the provisioning system 140, the terminal 150, the base system 160, and the terminal 165. The network 145 may be the Internet, a wide area network, a local area network, or the like, and may include a mobile network. In the present drawing, the network 125 and the network 145 are separate networks, but instead, the network 125 and the network 145 may be the same network.

The terminal 150 is a terminal used by the setter who sets the delivery target network device 100 at the delivery destination of the delivery target network device 100. This setter is a tenant who uses the network device 100, or a member of an installation agency or the like, for example. In the present embodiment, the terminal 150 is a smart phone, a tablet computer, a PC, or the like, for example. The terminal 150 is used in order to utilize the provisioning service provided by the provisioning system 140, acquires the device identification information and the like from the code label 102 of the delivery target network device 100, and issues a request for activation of the delivery target network device 100 to the provisioning system 140.

The base system 160 (foundation system 160) manages a network system in which a plurality of network devices 100 including the delivery target network device 100 are connected. As an example in the present embodiment, the base system 160 is a computing system functioning as the service providing system that provides the service for constructing the network system. The base system 160 may be a cloud computing system or the like, and may be realized by one or more server computers or the like. The network system constructed using the base system 160 is a device network such as an IoT or IIoT system, for example. The base system 160 functions as a cloud computer or the like that controls the plurality of network devices 100 in the network system. The base system 160 acquires sense data from one or more network devices 100 equipped with sensors or the like, and performs information processing such as providing an interface that shows information to the user, an observer, or the like via the terminal 165, and instead of or in addition to this, controlling the network devices 100 equipped with actuators or the like by performing control calculations according to the sense data. The base system 160 according to the present embodiment provides a unique account to each of a plurality of tenants that purchase and use the network device 100.

The terminal 165 is a terminal used by a user of the network system in which the plurality of network devices 100 are connected. The terminal 165 may be a computer such as a PC (personal computer), a tablet computer, a smart phone, a work station, a server computer, a general purpose computer, or the like, or may be a computer system in which a plurality of computers are connected. The terminal 165 is connected to the base system 160 via the network 145, and is used to utilize the network system construction service provided by the base system 160.

According to the device provisioning environment 10 shown above, it is possible to perform, before shipping, setting of the device identification information or the like for connecting the delivery target network device 100 to the base system 160, using the provisioning service provided by the provisioning system 120, and for the setter to easily set the delivery target network device 100 with the terminal 150, using the provisioning service provided by the provisioning system 140. In this way, the device provisioning environment 10 can provide plug and play usability, or nearly this level of usability, for the network device 100. Furthermore, by having the provisioning system 120 store the device authentication information in the network device 100 before shipping and having the provisioning system 140 authenticate the network device 100 using the device authentication information after delivery, it is possible to prevent a network device other than the delivery target network device 100 from being connected fraudulently to the base system 160 and threatening the security of the network system.

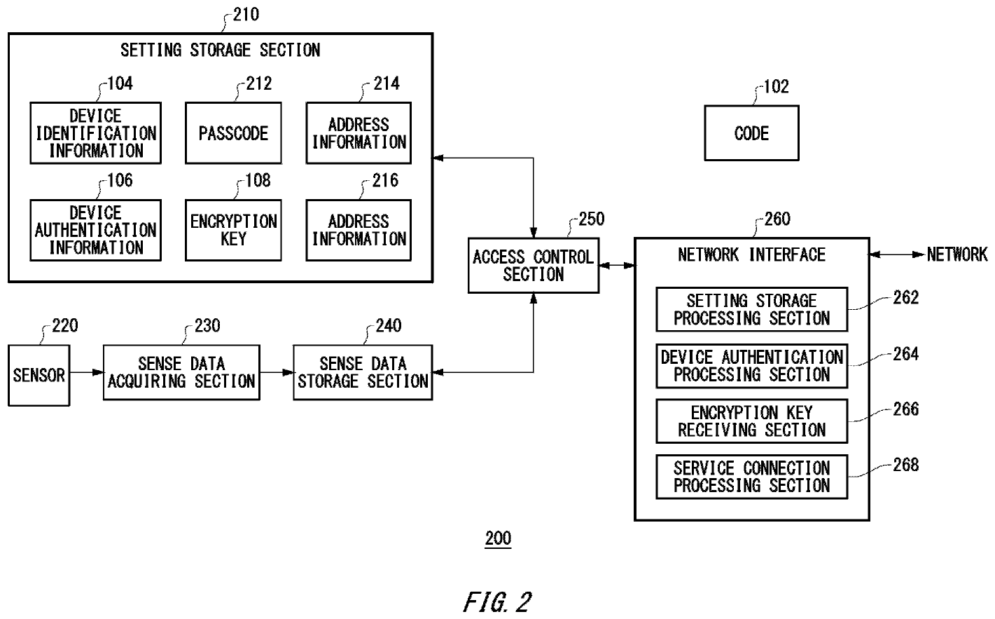

FIG. 2 shows a sensor apparatus 200, which is an example of the network device 100 according to the present embodiment. The sensor apparatus 200 includes the code label 102, a setting storage section 210, a sensor 220, a sense data acquiring section 230, a sense data storage section 240, an access control section 250, and a network interface 260. The code label 102 is a label that is affixed to the body or an accessory of the network device 100 and shows the code obtained by encoding the device identification information and the like, and functions as a device identification information providing section that provides the device identification information of the sensor apparatus 200 in a manner acquirable by the terminal 150. This code may be a bar code or two-dimensional code (QR code (Registered Trademark)), or may be any code that can be read from an image by the terminal 150, such as a character string. Instead, the sensor apparatus 200 may hold the device identification information and the like in a form that can be acquired by the terminal 150 through short-range wireless communication or the like, i.e. in the form of a non-contact IC card or the like, for example.

The setting storage section 210 stores setting information within the sensor apparatus 200. The sensor apparatus 200 includes the identification information storage region 104, a passcode storage region 212, an address information storage region 214, the authentication information storage region 106, the encryption key storage region 108, and an address information storage region 216. The identification information storage region 104 is a region for storing the device identification information of the sensor apparatus 200 determined by the provisioning system 120, before shipping of the sensor apparatus 200, and functions as a device identification information storage section.

The passcode storage region 212 is a region for storing, before delivery of the sensor apparatus 200, a passcode used when the terminal 150 issues the request for the activation process of the sensor apparatus 200 to the provisioning system 140, and functions as a passcode storage section. The network device 100 such as the sensor apparatus 200 according to the present embodiment is activated using the passcode in addition to the device identification information, but instead, the sensor apparatus 200 or the like does not need to include the passcode storage region 212 and may be activated without using a passcode. The address information storage region 214 is a region for storing, before delivery of the sensor apparatus 200, address information of the provisioning system 140, i.e. a URL or the like of the provisioning system 140, for example, and functions as an address information storage section for an address of the provisioning system 140.

The authentication information storage region 106 is a region for storing, before delivery of the sensor apparatus 200, the device authentication information used for authenticating the sensor apparatus 200 with the provisioning system 140, and functions as a device authentication information storage section. The encryption key storage region 108 is a region for storing the encryption key for connecting the sensor apparatus 200 to the base system 160, and functions as an encryption key storage section. The address information storage region 216 is a region for storing the address information of the base system 160, and functions as an address information storage section for an address of the base system 160. Among the storage regions of the setting storage section 210, at least the authentication information storage region 106 and the encryption key storage region 108 may be secure storage regions that cannot be fraudulently read.

The sensor 220 is a sensor that measures a physical quantity, such as a temperature sensor, a humidity sensor, a flow velocity sensor, a pressure sensor, a voltage sensor, a current sensor, or the like, for example. The sensor apparatus 200 may include two or more sensors 220.

The sense data acquiring section 230 converts a signal from the sensor 220 into sense data. For example, the sense data acquiring section 230 converts an analog signal input from the sensor 220 into a digital signal, to obtain the sense data. The sense data storage section 240 stores the sense data. The sense data stored in the sense data storage section 240 may include the time at which this sense data was measured, in which case the sensor apparatus 200 may include a time measuring section (not shown in the drawings) the performs time measurement. The access control section 250 accesses the data in the setting storage section 210 and the sense data storage section 240 and provides this data to the network interface 260, in response to a request from the network interface 260. The access control section 250 writes various types of setting data to the setting storage section 210, in response to a request from the network interface 260.

The network interface 260 is connected to a network such as the network 125 and the network 145, and instructs the access control section 250 to access the setting storage section 210 or the sense data storage section 240 in response to a request or the like received via the network. The network interface 260 may be connectable to a communication line such as Ethernet (Registered Trademark); a mobile line such as a 3G line, a 4G line, or an LTE line; a communication line intended for IoT, such as LoRa; or the like.

The network interface 260 includes a setting storage processing section 262, a device authentication processing section 264, an encryption key receiving section 266, and a service connection processing section 268. In a state where the sensor apparatus 200 is connected to the terminal 130 before delivery of the sensor apparatus 200, the setting storage processing section 262 receives from the terminal 130 the information to be set in the sensor apparatus 200 before shipping, such as the device identification information, the passcode, the address information of the provisioning system 140, and the device authentication information, and stores these pieces of information in the identification information storage region 104, the passcode storage region 212, the address information storage region 214, the authentication information storage region 106, and the like. The device authentication processing section 264, in response to the sensor apparatus 200 being connected to the network 145, uses the device authentication information stored in the authentication information storage region 106 to authenticate the sensor apparatus 200 with the provisioning system 140. The encryption key receiving section 266 receives the encryption key for accessing the network system construction service provided by the base system 160, from the provisioning system 140 that authenticated the sensor apparatus 200, and stores this encryption key in the encryption key storage region 108. The service connection processing section 268 connects to the base system 160 that provides the network system construction service, using the encryption key stored in the encryption key storage region 108.

According to the sensor apparatus 200 shown above, it is possible to store the device authentication information provided from the provisioning system 120 in the authentication information storage region 106 within the sensor apparatus 200, before shipping of the sensor apparatus 200, and to authenticate the sensor apparatus 200 with the base system 160 during installation of the sensor apparatus 200, using the stored device authentication information. Accordingly, the sensor apparatus 200 is connectable to the provisioning system 140 and the base system 160 only in the case where the sensor apparatus 200 is the correct product ordered by the user and set up by the provider, and a fraudulent product obtained by stealing the device identification information affixed to the sensor apparatus 200 and setting this device identification information in another network device cannot connect to the provisioning system 140 and the base system 160.

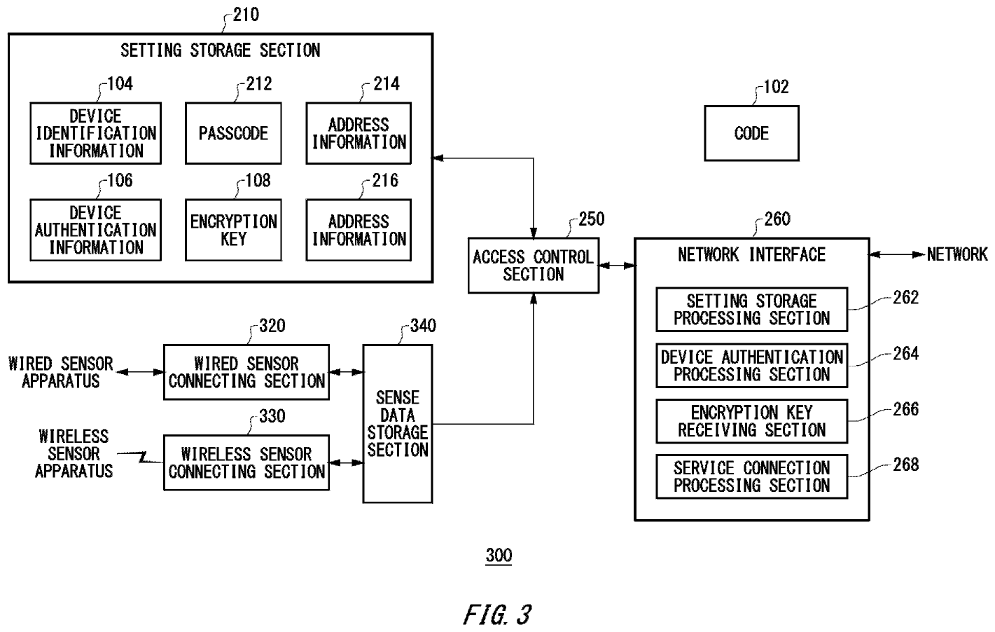

FIG. 3 shows a sensor gateway apparatus 300 that is an example of the network device 100 according to the present embodiment. The sensor gateway apparatus 300 includes the code label 102, the setting storage section 210, a wired sensor connecting section 320, a wireless sensor connecting section 330, a sense data storage section 340, the access control section 250, and the network interface 260. Among the components shown in the present drawing, components given the same reference numerals as in FIG. 2 have similar functions and configurations as in FIG. 2, and therefore the following description includes only differing points.

The wired sensor connecting section 320 is connected to, and communicates with, one or more sensor apparatuses through a wired connection using a local area network, USB, or the like. The wireless sensor connecting section 330 is connected to a sensor apparatus or the like by a wireless connection such as LoRa, a mobile line, wireless LAN, or Bluetooth (Registered Trademark), and communicates with one or more sensor apparatuses.

The sense data storage section 340 stores the sense data from one or more sensors connected to the wired sensor connecting section 320 and the wireless sensor connecting section 330. The access control section 250 accesses the data within the setting storage section 210 and the sense data storage section 340 and provides this data to the network interface 260, in response to a request from the network interface 260. Furthermore, the access control section 250 writes various types of setting data to the setting storage section 210, in response to a request from the network interface 260.

The network device 100 may be connectable to a field device having a control target such as an actuator. Such a network device 100 can adopt a configuration in which the network interface 260 receives control data for controlling the control target, the access control section 250 stores the control data in a control data storage section such as a memory, and the wired sensor connecting section 320 or the wireless sensor connecting section 330 transmits the control data to the field device.

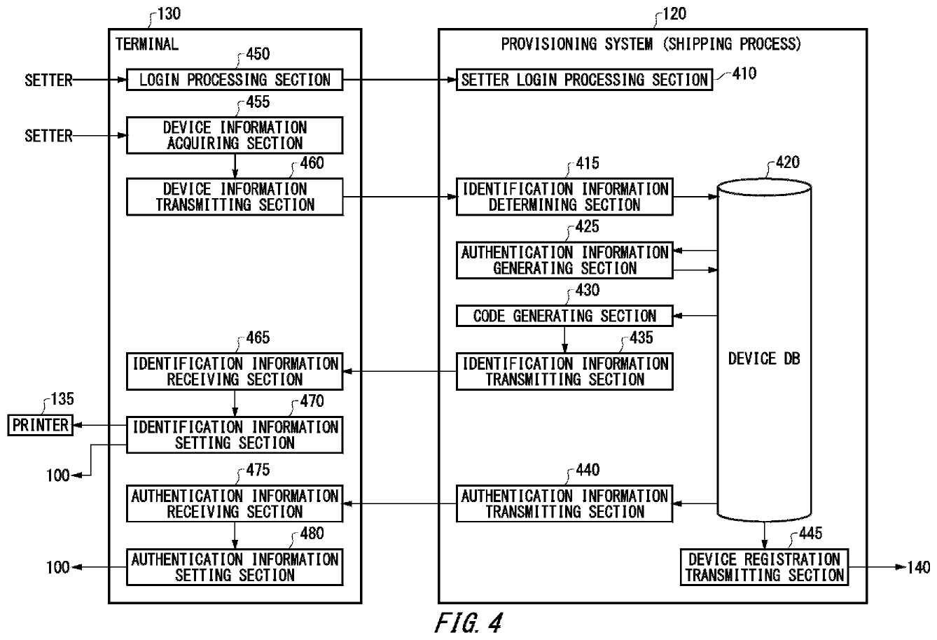

FIG. 4 shows configurations of the provisioning system 120 and the terminal 130 according to the present embodiment. The provisioning system 120 includes a setter login processing section 410, an identification information determining section 415, a device DB 420, an authentication information generating section 425, a code generating section 430, an identification information transmitting section 435, an authentication information transmitting section 440, and a device registration transmitting section 445.

The setter login processing section 410 receives a login of the setter who sets the delivery target network device 100, from the terminal 130, before delivery of the delivery target network device 100. This setter may be a person who sets the delivery target network device 100, such as an employee of the provider of the delivery target network device 100, and the setter login processing section 410 receives a login to an account of this provider from the terminal 130.

The identification information determining section 415 receives device information relating to the delivery target network device 100, which is acquired by the terminal 130 in response to instructions from the setter, and determines the device identification information, before delivery of the delivery target network device 100. The identification information determining section 415 registers the delivery target network device 100 in the device DB 420, by adding the device identification information to the device information of the delivery target network device 100 and writing the resulting device information to the device DB 420. Here, the identification information determining section 415 determines the passcode to be set in the delivery target network device 100 using random numbers or the like, adds this information to the device information, and writes the resulting device information to the device DB 420.

The device DB 420 stores the device information relating to a plurality of network devices 100 that are targets of the provisioning service. The device information stored by the device DB 420 includes the device identification information and the device authentication information set by the authentication information generating section 425. The device information may include any of the pieces of information included in the device information received from the terminal 130, such as provider identification information, a serial number, model identification information such as the model name, and tenant identification information, and may include a passcode to be set in the delivery target network device 100, the address information of the provisioning system 140, the address information of the base system 160, and the like. Furthermore, the device information may include a PKI (Public-Key Infrastructure) authentication of the delivery target network device 100 for the provisioning system 140, a public key of the delivery target network device 100 used for encrypted communication between the delivery target network device 100 and other devices, and the like.

The authentication information generating section 425 generates the device authentication information for authenticating the delivery target network device 100 at the delivery destination, in response to the device information of the delivery target network device 100 being registered in the device DB 420. The authentication information generating section 425 writes the generated device authentication information to the device DB 420, to add this device authentication information to the device information of the delivery target network device 100.

The code generating section 430 generates a code, obtained by encoding the device identification information, to be provided by being at least one of affixed to, printed on, and engraved on the body or an accessory of the delivery target network device 100. In the present embodiment, the code generating section 430 generates a code by encoding, in addition to the device identification information, the passcode and the address information of the provisioning system 140.

The identification information transmitting section 435 transmits the device identification information to the delivery target terminal 130, to set the device identification information to be acquirable from the body or an accessory of the delivery target network device 100 at the delivery destination. In the present embodiment, the identification information transmitting section 435 transmits the code generated by the code generating section 430 to the terminal 130 and causes the code to be printed from the printer 135 by the terminal 130, and the printed code is affixed to the body or an accessory of the delivery target network device 100 by the setter. The code may be provided by being at least one of affixed to, printed on, and engraved on the body or an accessory of the delivery target network device 100, and as an example, part of the code may be provided by printing and the remaining part of the code may be provided by engraving. Furthermore, the identification information transmitting section 435 transmits the device identification information of the delivery target network device 100, the passcode, and the address information of the provisioning system 140 to the terminal 130, and causes these pieces of information to be written to the identification information storage region 104, the passcode storage region 212, and the address information storage region 214 within the delivery target network device 100.

The authentication information transmitting section 440 transmits the device authentication information to the terminal 130, to store this device authentication information in the authentication information storage region 106 of the delivery target network device 100. Furthermore, the authentication information transmitting section 440 transmits the address information of the base system 160 to the terminal 130, to store this address information in the address information storage region 216 of the delivery target network device 100.

The device registration transmitting section 445 transmits the device information registered in the device DB 420 to the provisioning system 140.

The terminal 130 includes a login processing section 450, a device information acquiring section 455, a device information transmitting section 460, an identification information receiving section 465, an identification information setting section 470, an authentication information receiving section 475, and an authentication information setting section 480. These functions may be realized by the terminal 130 performing a process of a Web page relating to the provisioning service of the provisioning system 120.

The login processing section 450 performs a login process to the provisioning system 120, in response to instructions from the setter operating the terminal 130. The device information acquiring section 455 acquires the device information of the delivery target network device 100 while the setter is logged in. The device information transmitting section 460 transmits the acquired device information to the identification information determining section 415 in the provisioning system 120.

The identification information receiving section 465 receives the device identification information from the identification information transmitting section 435 of the provisioning system 120. The identification information receiving section 465 according to the present embodiment receives the code generated by the code generating section 430 in the provisioning system 120, the device identification information, the passcode, and the identification information of the provisioning system 140.

The identification information setting section 470 sets the device identification information in the delivery target network device 100, such that the device identification information is acquirable from the body or an accessory of the delivery target network device 100 at the delivery destination. In the present embodiment, the identification information setting section 470 causes the code received by the identification information receiving section 465 to be printed on a label by the printer 135, and this code label 102 is affixed to the body of the delivery target network device 100 by the setter. Furthermore, the identification information setting section 470 receives the device identification information, the passcode, and the identification information of the provisioning system 140, from the provisioning system 120, and writes these pieces of information to the identification information storage region 104, the passcode storage region 212, and the address information storage region 214 in the delivery target network device 100.

The authentication information receiving section 475 receives the device authentication information from the provisioning system 120. The authentication information setting section 480 stores the received device authentication information in the authentication information storage region 106 of the delivery target network device 100.

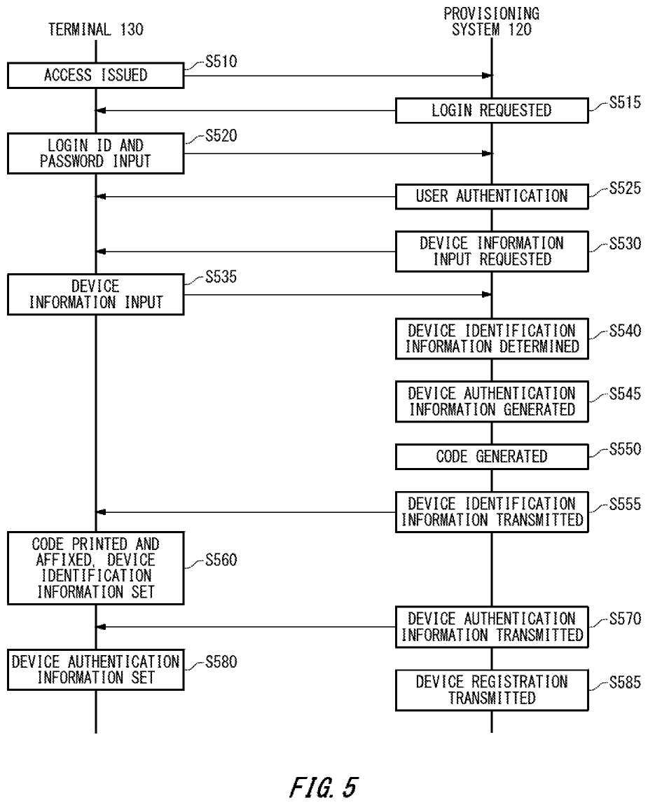

FIG. 5 shows a process flow of the provisioning system 120 and the terminal 130 according to the present embodiment. At S510 (step S510), the login processing section 450 in the terminal 130 issues access to the provisioning system 120, in response to instructions from the setter. At S515, the setter login processing section 410 in the provisioning system 120 transmits a login screen to the terminal 130 in response to the access from the provisioning system 120, and requests a login.

At S520, the login processing section 450 in the terminal 130 receives the input of a login ID and a password from the setter, and transmits the login ID and the password to the provisioning system 120. At S525, the setter login processing section 410 in the provisioning system 120 performs user authentication based on the login ID and the password, and performs a login to the account corresponding to the login ID in response to successful authentication. After this, the processes from S530 to S580 are performed while the setter is logged in.

At S530, the provisioning system 120 transmits a screen for inputting the device information of the delivery target network device 100 to the terminal 130, and requests input of the device information. The device information acquiring section 455 in the terminal 130 receives this request and, at S535, receives the input to the screen for inputting the device information and acquires the device information of the delivery target network device 100. The device information acquiring section 455 may acquire the device information from the delivery target network device 100 by communicating with the delivery target network device 100. The device information transmitting section 460 transmits the acquired device information to the provisioning system 120.

At S540, the identification information determining section 415 in the provisioning system 120 receives the device information and determines the device identification information. Furthermore, the identification information determining section 415 may further determine the passcode of the delivery target network device 100. The identification information determining section 415 adds the determined device identification information and the like to the device information received from the device information transmitting section 460, and registers the resulting device information in the device DB 420. Since the delivery target network device 100 can be uniquely identified in the network, the identification information determining section 415 may determine the device identification information by combining pieces of information included in the provider identification information unique to the provider of the delivery target network device 100 and in the device information, such as the serial number of the delivery target network device 100, and if necessary, a sufficient amount of other information to specify the delivery target network device 100, for example.

At S545, the authentication information generating section 425 in the provisioning system 120 generates the device authentication information of the delivery target network device 100 and adds this device authentication information to the device information in the device DB 420. For example, the authentication information generating section 425 may generate, as the device authentication information, a digital certificate on which the provisioning system 120 has made an electronic signature for at least a portion of the device information of the delivery target network device 100. As an example, the authentication information generating section 425 may generate a digital certificate enabling the provisioning system 140 to authenticate the delivery target network device 100 using PKI authentication. At S550, the code generating section 430 generates the code obtained by encoding information including the device identification information, the passcode, and the address information of the provisioning system 140.

At S555, the identification information transmitting section 435 in the provisioning system 120 transmits the device identification information to the terminal 130. Here, the identification information transmitting section 435 transmits the code generated at S550, the device identification information of the delivery target network device 100, the passcode, and the address information of the provisioning system 140 to the terminal 130.

At S560, the identification information receiving section 465 in the terminal 130 receives the device identification information and the like transmitted at S555. The identification information setting section 470 prints the code generated at S550 using the printer 135, and the printed code is affixed to the body or the like of the network device 100 by the setter. Furthermore, the identification information setting section 470 sets the device identification information of the delivery target network device 100, the passcode, and the address information of the provisioning system 140 in the delivery target network device 100.

At S570, the authentication information transmitting section 440 in the provisioning system 120 transmits the device authentication information of the delivery target network device 100. Here, the authentication information transmitting section 440 may transmit a file including the device authentication information to the terminal 130. At S580, the authentication information receiving section 475 receives the device authentication information, and the authentication information setting section 480 sets the device authentication information in the delivery target network device 100. At S585, the device registration transmitting section 445 transmits the device information of the network device 100 registered in the device DB 420 to the provisioning system 140.

According to the provisioning system 120 and the terminal 130 described above, it is possible to set the device identification information acquirable from the body or an accessory of the delivery target network device 100 at the delivery destination and device authentication information for authenticating the delivery target network device 100 connected to the network at the delivery destination, through a login from the terminal 130 to the provisioning service and an interactive task. In this way, the delivery target network device 100 can be connected easily and securely to the provisioning system 140 by the setting process performed after delivery.

In the above, the provisioning system 120 and the terminal 130 set the delivery target network device 100 through the login process and the subsequent interactive process. Instead, the terminal 130 may automatically transmit the provider information and the device information to the provisioning system 120 without using an interactive process, print the code received from the provisioning system 120, and write the device identification information of the delivery target network device 100, the passcode, and the address information provisioning system 140 received from the provisioning system 120 to the delivery target network device 100.

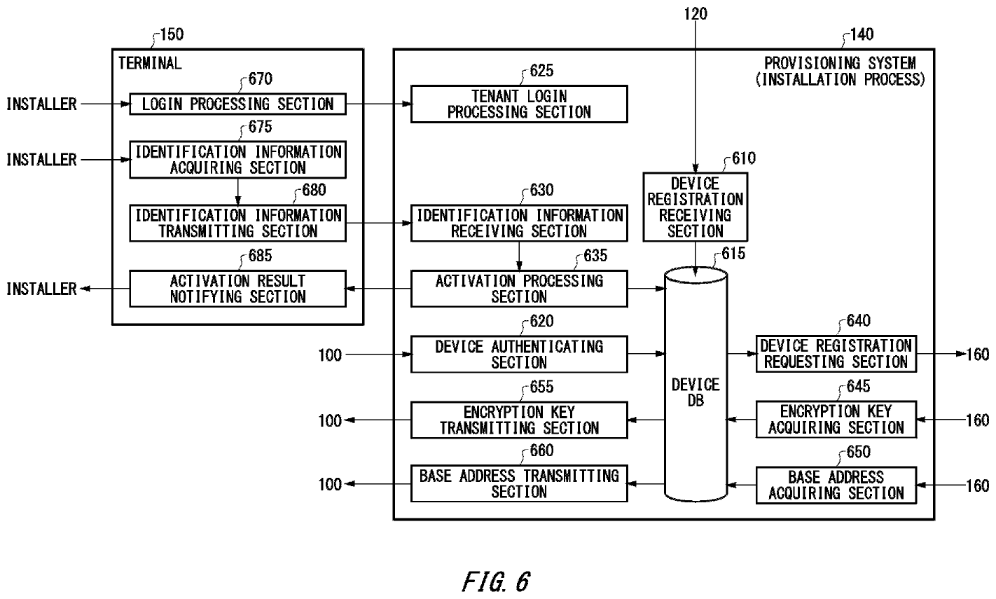

FIG. 6 shows configurations of the provisioning system 140 and the terminal 150 according to the present embodiment. The provisioning system 140 includes a device registration receiving section 610, a device DB 615, a device authenticating section 620, a tenant login processing section 625, an identification information receiving section 630, an application processing section 635, a device registration requesting section 640, an encryption key acquiring section 645, a base address acquiring section 650, an encryption key transmitting section 655, and a base address transmitting section 660.

The device registration receiving section 610 receives the device information transmitted by the device registration transmitting section 445 in the provisioning system 120, and registers this device information in the device DB 615. The device DB 615 stores the device information relating to the plurality of network devices 100 that are targets of the provisioning service. The device information stored by the device DB 615 may include, in addition to the device information stored by the device DB 420, the encryption key for connecting the delivery target network device 100 to the base system 160 and the address information of the base system 160 to which the delivery target network device 100 is to be connected. In a case where the network device 100 is a sensor apparatus 200, the device information stored in the device DB 615 may further include sense data identification information for identifying the sense data output by the sensor apparatus 200. The sense data identification information may be identification information unique to the installation position and physical quantity measured by the sensor apparatus 200, and may be shown as a combination of the measured physical quantity and an identification number, for example. In a case where the sense data relates to the temperature of a second belt conveyor in equipment that performs a first processing step, for example, the sense data identification information may be shown as “Temp1”. Instead, the sense data identification information may be shown as a hierarchy by a combination of the installation position and the measured physical quantity, and may be shown as “manufacturing step (1)—belt conveyor (2)—temperature”, for example.

The device authenticating section 620 authenticates the delivery target network device 100 connected to the network 125 at the delivery destination, using the device authentication information stored in the delivery target network device 100. The device authenticating section 620 adds authenticated information indicating that the delivery target network device 100 has been authenticated to the device information in the device DB 615, in response to the delivery target network device 100 being successfully authenticated.

The tenant login processing section 625 receives the login of the tenant from the terminal 150 used by an installer, who is a user of the tenant of the delivery destination, at the delivery destination of the delivery target network device 100. The identification information receiving section 630 receives the passcode and the device identification information acquired from the body or an accessory of the delivery target network device 100 by the terminal 150 used at the delivery destination. The application processing section 635 performs the process for activating the delivery target network device 100 to which the received device identification information has been allocated, in response to the device identification information of the delivery target network device 100 being received.

The device registration requesting section 640 transmits the device information of the delivery target network device 100 that is undergoing the activation process to the base system 160, and issues a request to the base system 160 to register the delivery target network device 100 with the network system construction service provided by the base system 160. The encryption key acquiring section 645 acquires from the base system 160 the encryption key to be used by the delivery target network device 100 to connect to the network system construction service, and adds the encryption key to the device information of the delivery target network device 100 in the device DB 615. The base address acquiring section 650 acquires from the base system 160 the address information of the base system 160 used to connect the delivery target network device 100 to the base system 160, and adds this address information to the device information of the delivery target network device 100 in the device DB 615.

The encryption key transmitting section 655 transmits the encryption key acquired by the encryption key acquiring section 645 to the delivery target network device 100, to store the encryption key in the encryption key storage region 108, in response to the delivery target network device 100 being successfully authenticated. The base address transmitting section 660 transmits the address information acquired by the base address acquiring section 650 to the delivery target network device 100, to store this address information in the address information storage region 216, in response to the delivery target network device 100 being successfully authenticated.

The terminal 150 includes a login processing section 670, an identification information acquiring section 675, an identification information transmitting section 680, and an activation result notifying section 685. The login processing section 670 performs the login process to the provisioning system 140 in response to instructions from the installer who installs the delivery target network device 100 after the delivery target network device 100 has been delivered.

The identification information acquiring section 675 acquires the device identification information of the delivery target network device 100 from the body or an accessory of the delivery target network device 100, while the installer of the tenant is logged in. In the present embodiment, the identification information acquiring section 675 is operated by the installer to capture an image of the code label 102 affixed to the body of the delivery target network device 100 and recognize the code included in the captured image to reproduce the encoded device identification information, passcode, and address information of the provisioning system 140.

The identification information transmitting section 680 transmits the device identification information and the passcode acquired by the identification information acquiring section 675 to the provisioning system 140 designated by the address information acquired by the identification information acquiring section 675, and requests activation of the delivery target network device 100. The activation result notifying section 685 receives the activation result of the delivery target network device 100 from the provisioning system 140, and notifies the installer who uses the terminal 150.

In the present embodiment, an example is shown in which the provisioning system 120 and the provisioning system 140 are different computer systems, but the provisioning system 120 and the provisioning system 140 may be realized by the same computer system, and the shipping provisioning service and installation provisioning service may be provided by the same service agent. In such a configuration, basically, each configurational component of the provisioning system 120 of FIG. 4 and the provisioning system 140 of FIG. 6 may be included in a provisioning system. In this case, the device DB 420 in the provisioning system 120 and the device DB 615 in the provisioning system 140 are shared, and there is no need to provide the device registration transmitting section 445 and the device registration receiving section 610.

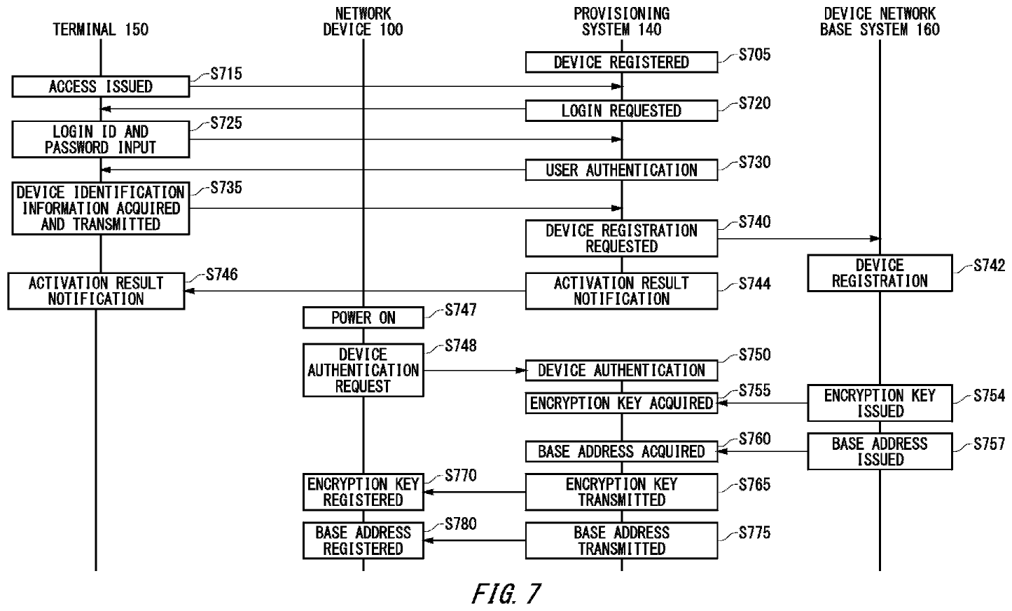

FIG. 7 shows a process flow of the terminal 150, the network device 100, the provisioning system 140, and the base system 160 according to the present embodiment. At S705, the device registration receiving section 610 in the provisioning system 140 receives the device information from the device registration transmitting section 445 in the provisioning system 120, and registers this device information in the device DB 615.

At S715, the tenant login processing section 625 of the provisioning system 140 issues access to the provisioning system 140, in response to instructions from the installer who is a user of the tenant. At S720, the login processing section 670 in the terminal 150 transmits the login screen to the terminal 150 in response to the access from the terminal 150, and requests a login.

At S725, the terminal 150 receives the input of the login ID and the password from the installer, and transmits the login ID and password to the provisioning system 140. At S730, the tenant login processing section 625 in the base system 160 performs user authentication based on the login ID and password, and performs a login to the account of the tenant corresponding to this login ID, in response to successful authentication. After this, the processes from S735 to S775 are performed while the installer of the tenant is logged in.

At S735, the identification information acquiring section 675 in the terminal 150 acquires the device identification information of the delivery target network device 100. In the present embodiment, the identification information acquiring section 675 captures an image of the code label 102 and recognizes the code included in the captured image to reproduce the encoded device identification information, passcode, and address information of the provisioning system 140. The identification information transmitting section 680 in the terminal 150 transmits the device identification information and the passcode acquired by the identification information acquiring section 675 to the provisioning system 140 designated by the address information acquired by the identification information acquiring section 675, and requests activation of the delivery target network device 100. In a case where the delivery target network device 100 is a sensor apparatus 200, the identification information acquiring section 675 may acquire the installation position and physical quantity measured by the sensor apparatus 200 and generate the sense data identification information based on the manipulation of the sensor apparatus 200 by the installer, and the identification information transmitting section 680 may transmit this sense data identification information to the provisioning system 140.

At S740, the identification information receiving section 630 in the provisioning system 140 receives the activation request including the device identification information and the like transmitted from the terminal 150. The application processing section 635 in the provisioning system 140 performs the activation process, with the delivery target network device 100 to which the received device identification information has been allocated serving as the network device 100 of the tenant. The application processing section 635 according to the present embodiment adds status information, which indicates that the delivery target network device 100 is in the midst of the activation process, to the device information in the device DB 615 corresponding to this device identification information, such that the activation process proceeds in the provisioning system 140. In a case where the delivery target network device 100 is a sensor apparatus 200, the application processing section 635 may add sense data identification information for identifying the sense data output by this sensor apparatus 200 to the device information in the device DB 615. The application processing section 635 may start the activation of the delivery target network device 100 on a condition that the device identification information and the passcode received from the terminal 150 match the device identification information and the passcode included in the device information in the device DB 615. The device registration requesting section 640 acquires from the device DB 615 the device information of the delivery target network device 100 in which the address information of the base system 160 and the encryption key from the base system 160 have yet to be acquired during the activation process. The device registration requesting section 640 transmits the acquired device information to the base system 160, and issues a request to the base system 160 to register the delivery target network device 100 with the network system construction service provided by the base system 160.

At S742, the base system 160 that has received the device registration of the delivery target network device 100 from the provisioning system 140 registers the device information of the delivery target network device 100. As an example, in a case where the delivery target network device 100 is a sensor apparatus 200, the base system 160 stores the sense data identification information acquired for this sensor apparatus 200 in association with the device identification information of this sensor apparatus 200. Furthermore, the base system 160 stores the sense data identification information in association with a storage region of the sense data output by the sensor apparatus 200. The base system 160 may notify the provisioning system 140 that the device information has been correctly registered.

At S744, in response to the process of S740 (or S740 and S742 having been correctly completed, the application processing section 635 in the provisioning system 140 notifies the terminal 150 about the activation result indicating that the delivery target network device 100 has been correctly activated. At S790, the activation result notifying section 685 in the terminal 150 receives the activation result of the delivery target network device 100 from the provisioning system 140, and notifies the installer using the terminal 150.

At S747, the delivery target network device 100 is connected to the network 145 and turned ON, and performs the initialization process. At S748, the delivery target network device 100 issues a request for device authentication of the delivery target network device 100 to the provisioning system 140. Specifically, the network interface 260 in the delivery target network device 100 accesses the setting storage section 210 via the access control section 250, and reads the address information of the provisioning system 140 stored in the address information storage region 214, the device identification information stored in the identification information storage region 104, the passcode stored in the passcode storage region 212, and the device authentication information stored in the authentication information storage region 106. The network interface 260 transmits a device authentication request including the read device identification information, passcode, and device authentication information to the provisioning system 140 designated by the address information read from the address information storage region 214.

At S750, the device authenticating section 620 in the provisioning system 140 receives the device authentication request from the delivery target network device 100, and performs authentication using the device authentication information from the delivery target network device 100. The provisioning system 140 according to the present embodiment checks whether the delivery target network device 100 is a legitimate product that has been correctly shipped by the provisioning system 120, using PKI authentication that uses the device authentication information. In response to the delivery target network device 100 being successfully authenticated, the device authenticating section 620 adds the authenticated information to the device information of the delivery target network device 100 in the device DB 615. The provisioning system 140 may notify the base system 160 about the device information to which the authenticated information has been added in the device DB 615.

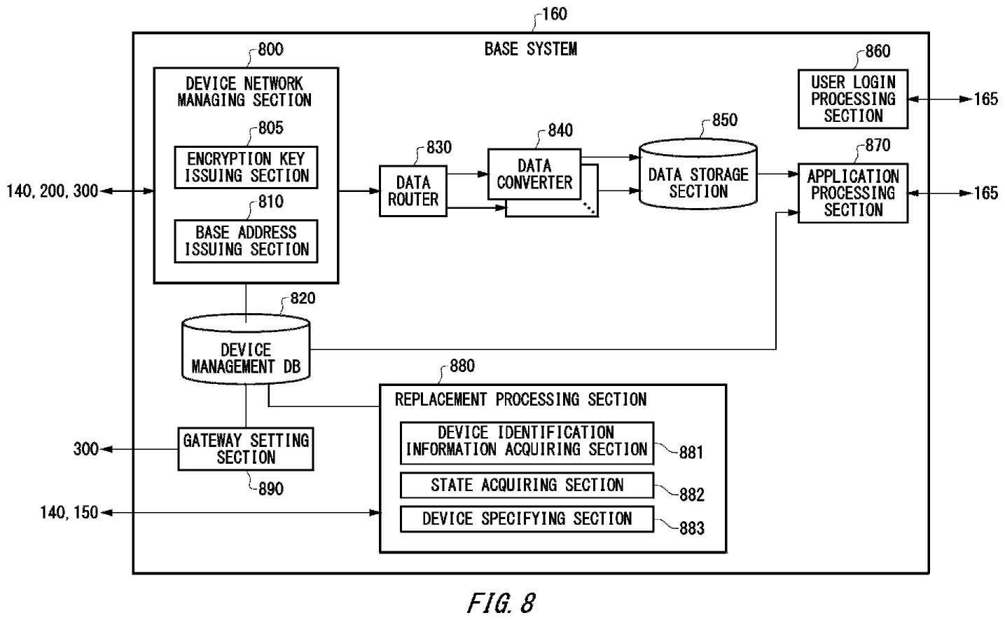

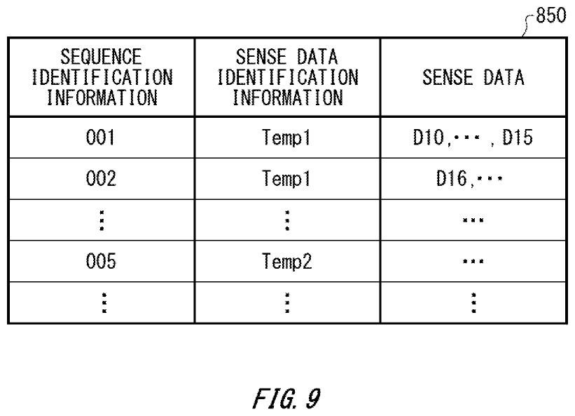

At S754, the base system 160 issues the encryption key for connecting the delivery target network device 100 to the network system construction service provided by the base system 160, to the delivery target network device 100 that has been authenticated by the provisioning system 140 and whose device information has been registered in the base system 160. At S757, the base system 160 issues the address information of the base system 160 used to connect the delivery target network device 100 to the base system 160. The configuration and detailed operation of the base system 160 are described further below in FIGS. 8 and 9.

At S755, the encryption key acquiring section 645 in the provisioning system 140 acquires the encryption key issued by the base system 160, and adds this encryption key to the device information in the device DB 615. At S760, the base address acquiring section 650 in the provisioning system 140 acquires the address information of the base system 160 from the base system 160, and adds this address information to the device information in the device DB 615.

At S765, the encryption key transmitting section 655 in the provisioning system 140 transmits the encryption key acquired by the encryption key acquiring section 645 to the delivery target network device 100. The encryption key transmitting section 655 may encrypt the encryption key with a public key of the delivery target network device 100 and then transmit the encrypted encryption key, such that the encryption key is not fraudulently acquired by a device other than the delivery target network device 100. At S770, the encryption key receiving section 266 of the delivery target network device 100 receives the encryption key transmitted from the provisioning system 140, and registers this encryption key to the encryption key storage region 108 in the setting storage section 210 using the access control section 250.

At S775, the base address transmitting section 660 in the provisioning system 140 transmits the address information acquired by the base address acquiring section 650 to the delivery target network device 100. At S780, the service connection processing section 268 of the delivery target network device 100 receives the address information transmitted from the provisioning system 140, and registers this address information to the address information storage region 216 in the setting storage section 210 using the access control section 250.

According to the provisioning system 140 and the terminal 150 shown above, the delivery target network device 100 can be authenticated using the device authentication information stored in the delivery target network device 100 before delivery, and the installation provisioning service can be securely provided to the network device 100 set up by the shipping provisioning service. Furthermore, according to the provisioning system 140 and the terminal 150, the activation of the delivery target network device 100 can progress easily, by having the terminal 150 acquire the device identification information and the like from the body or an accessory of the delivery target network device 100 and provide this device information and the like to the provisioning system 140.

The operations described above may be performed in another processing order. For example, in the above description, the encryption key is issued by performing the authentication of the network device 100 in S747 to S750 after the activation of the network device 100 in S715 to S746, but instead, the encryption key may be issued by performing the activation of the network device 100 in S715 to S746 after the authentication of the network device 100 in S747 to S750.

FIG. 8 shows a configuration of the base system 160 according to the present embodiment. The base system 160 includes a device network managing section 800, a device management DB 820, a device router 830, one or more data converters 840, a data storage section 850, a user login processing section 860, an application processing section 870, a replacement processing section 880, and a gateway setting section 890.

The device network managing section 800 is connected to the provisioning system 140 and one or more network devices 100 (e.g. a sensor apparatus 200 and a sensor gateway apparatus 300), via the network 145, and manages the one or more network devices 100. The device network managing section 800 receives the device registration request from the base system 160, and stores the device information of the delivery target network device 100 in the device management DB 820. The device network managing section 800 includes an encryption key issuing section 805 and a base address issuing section 810. The encryption key issuing section 805 issues the encryption key for connecting the newly registered delivery target network device 100 to the network system construction service of the base system 160, in response to the device registration request, and transmits this encryption key to the provisioning system 140. The base address issuing section 810 issues the address information of the base system 160 used to connect the newly registered delivery target network device 100 to the base system 160, and transmits this address information to the provisioning system 140. Furthermore, the device network managing section 800 receives data used by the network system, such as sense data from each of the one or more network devices 100 for which registration has been completed, and supplies this data to the device router 830.

The device management DB 820 is a database that stores the device information of each network device 100, and functions as a device information storage section (device information storage region). The device management DB 820 stores the sense data identification information for identifying the sense data output by each sensor apparatus 200, in association with each of the plurality of sensor apparatuses 200. The device management DB 820 may further store, for each sensor apparatus 200, the device identification information of the sensor apparatus 200 and the state information indicating the state of the sensor apparatus 200. As an example, the state information of a sensor apparatus 200 may indicate whether the sensor apparatus 200 is active or inactive. The device management DB 820 may be connected to the device network managing section 800, and may store the device information of each network device 100 that received a device registration request from the provisioning system 140.

The device router 830 is connected to the base address issuing section 810, and routes the data received from each of one or more network devices 100 to the data converter 840 that is to perform the intended data conversion among the one or more data converters 840, in order to convert this received data into a data format to be used by the network system of the tenant. Each of the one or more data converters 840 is connected to the device router 830, converts the data received from the device router 830 into an intended data format, and outputs the converted data. As an example, the data converter 840 may normalize the sense data by bringing the units or orders of magnitude into agreement among the pieces of sense data for the same physical quantity.

The data storage section 850 is an example of a data storage region, and stores the sense data received from each of the plurality of sensor apparatuses 200 in association with the sense data identification information that is associated with the sensor apparatus 200 in the device management DB 820. As an example in the present embodiment, the data storage section 850 is connected to the one or more data converters 840, and stores the converted data output by the one or more data converters 840.

The user login processing section 860 is connected to the terminal 165 used by the user or the like of the tenant, via the network 145, and receives the login from the user or the like of the tenant. The application processing section 870 is connected to the terminal 165 and the device management DB 820, and provides an application development environment for processing data from the one or more network devices 100 of the tenant with which the user or the like who logged in is associated. Furthermore, the application processing section 870 executes the developed application and provides the user or the like of the tenant with the execution result via the terminal 165.

When the sensor apparatus 200 is replaced, the replacement processing section 880 performs a setting process relating to the sensor apparatuses 200 before and after replacement. For example, in response to a sensor apparatus (also referred to as a first sensor apparatus) 200 among a plurality of sensor apparatuses 200 being replaced with another sensor apparatus (also referred to as a second sensor apparatus) 200, the replacement processing section 880 sets sense data identification information (also referred to as first sense data identification information) that is associated with the first sensor apparatus 200 in the device management DB 820 as sense data identification information associated with the second sensor apparatus 200. As an example, the replacement processing section 880 stores the first sense data identification information that is associated with the first device identification information of the first sensor apparatus 200 that was replaced, in the device management DB 820, in association with the second device identification information of the second sensor apparatus 200 that is the replacement.

The replacement processing section 880 includes a device identification information acquiring section 881, a state acquiring section 882, and a device specifying section 883.

The device identification information acquiring section 881 acquires a set of device identification information of the first sensor apparatus 200 and device identification information of the second sensor apparatus 200. The device identification information acquiring section 881 may acquire each of the first device identification information and the second device identification information from any one of the provisioning system 140, the terminal 150, and the terminal 165. As an example, the device identification information acquiring section 881 may receive the first device identification information and the second device identification information, which are obtained by the terminal 150 capturing respective images of the code label 102 of the first sensor apparatus 200 and the code label 102 of the second sensor apparatus 200, from the terminal 150.

The state acquiring section 882 acquires, from the device management DB 820, state information (e.g. information indicating one of an active state and an inactive state) of the sensor apparatus 200 corresponding to each of the plurality of pieces of device identification information acquired by the device identification information acquiring section 881. In a case where the device identification information acquiring section 881 has acquired a plurality of pieces of device identification information without distinguishing between the sensor apparatus being replaced and the sensor apparatus that is the replacement, the device specifying section 883 specifies the device identification information of the sensor apparatus 200 being replaced and the device identification information of the sensor apparatus 200 that is the replacement. For example, among the plurality of pieces of device identification information acquired by the device identification information acquiring section 881, the device specifying section 883 specifies the device identification information associated with the active sensor apparatus 200 as the first device identification information of the first sensor apparatus 200 that is being replaced and specifies the device identification information associated with the sensor apparatus 200 that is inactive as the second device identification information of the second sensor apparatus 200 that is the replacement.

The gateway setting section 890 performs a setting for the sensor gateway apparatus 300 that relays communication between the base system 160 and at least one sensor apparatus 200 among the plurality of sensor apparatuses 200. For example, in a case where the first sensor apparatus 200 has been replaced with the second sensor apparatus 200, the gateway setting section 890 performs a setting to allow any one sensor gateway apparatus 300 to forward the sense data from the second sensor apparatus 200 to the base system 160. As an example, the gateway setting section 890 may perform a connection setting to connect to the second sensor apparatus 200 that is the replacement, for the wired sensor connecting section 320 or the wireless sensor connecting section 330 of the sensor gateway apparatus 300 that is set to be allowed to perform transmission. The gateway setting section 890 may perform a setting, for the sensor gateway apparatus 300 that was performing relay between the first sensor apparatus 200 and the base system 160, or for another sensor gateway apparatus 300, to perform relay between the second sensor apparatus 200 and the base system 160.

According to the base system 160 described above, the first sense data identification information is associated with the second sensor apparatus 200 in response to the first sensor apparatus 200 associated with the first sense data identification information, among the plurality of pieces of sense data identification information for identifying the sense data, being replaced with the second sensor apparatus 200. Accordingly, the first sense data identification information for identifying the sense data output by the first sensor apparatus 200 can be automatically inherited as the sense data identification information for identifying the sense data output by the second sensor apparatus 200, and the continuity of the sense data can be preserved. Accordingly, compared to a case where the setting of the base system 160 is performed manually to preserve the continuity of the sense data, it is possible to make the replacement of sensor apparatuses 200 simpler.

Furthermore, since the sensor gateway apparatus 300 is allowed to forward the sense data from the second sensor apparatus 200 that is the replacement to the base system 160, in a case where it is necessary for the sensor gateway apparatus 300 to perform relay between the base system 160 and the second sensor apparatus 200 that is the replacement, it is possible to reliably supply the base system 160 with the sense data from the second sensor apparatus 200 and preserve the continuity of the data. Furthermore, it is possible to eliminate the trouble of manually setting the sensor gateway apparatus 300.

Yet further, in a case where a plurality of pieces of device identification information are acquired by the device identification information acquiring section 881, the state of the sensor apparatus 200 corresponding to each piece of device identification information is acquired, the device identification information associated with the active sensor apparatus 200 is specified as the first device identification information of the sensor apparatus 200 that was replaced, and the device identification information associated with the inactive sensor apparatus 200 is specified as the second device identification information of the sensor apparatus 200 that is the replacement. Accordingly, the device identification information associated with the first sense data identification information can be reliably changed from the device identification information of the first sensor apparatus 200 to the device identification information of the second sensor apparatus 200.

FIG. 9 shows the data storage section 850 according to the present embodiment. For each sense data sequence, the data storage section 850 stores sequence identification information for identifying the sequence, one or more pieces of sense data included in the sequence, and sense data identification information for identifying the sense data in association with each other.

Here, as an example in the present embodiment, a sense data sequence is a collection of sense data measured over time by one sensor apparatus 200, and the sequence identification information is information for identifying the sequence. Therefore, when a sensor apparatus 200 is replaced, different sequence identification information is associated with the sense data from the sensor apparatus 200 before the replacement and the sense data from the sensor apparatus after the replacement. In contrast to this, the sense data identification information is identification information that is unique to the installation position and physical quantity measured by the sensor apparatus 200. Therefore, when a sensor apparatus 200 has been replaced, the same sense data identification information is associated with the sense data from the sensor apparatus 200 before the replacement and the sense data from the sensor apparatus 200 after the replacement. As an example, in FIG. 9, the sense data of the sequence of the first line and the sense data of the sequence of the second line are measured by different sensor apparatuses 200 before and after the replacement, and therefore these pieces of sense data are associated with different pieces of sequence identification information “001” and “002” and also associated with the same sense data identification information “Temp1”. As an example in the present embodiment, the sense data is data including the measurement result for each measurement timing at consecutive periods, but instead the data may include measurement results for the entire measurement interval.

According to the data storage section 850 described above, the sense data from the sensor apparatus 200 before the replacement and the sense data from the sensor apparatus 200 after the replacement are stored in association with different sequence identification information, and therefore it is possible to easily understand that the sense data is from different sensor apparatuses 200.

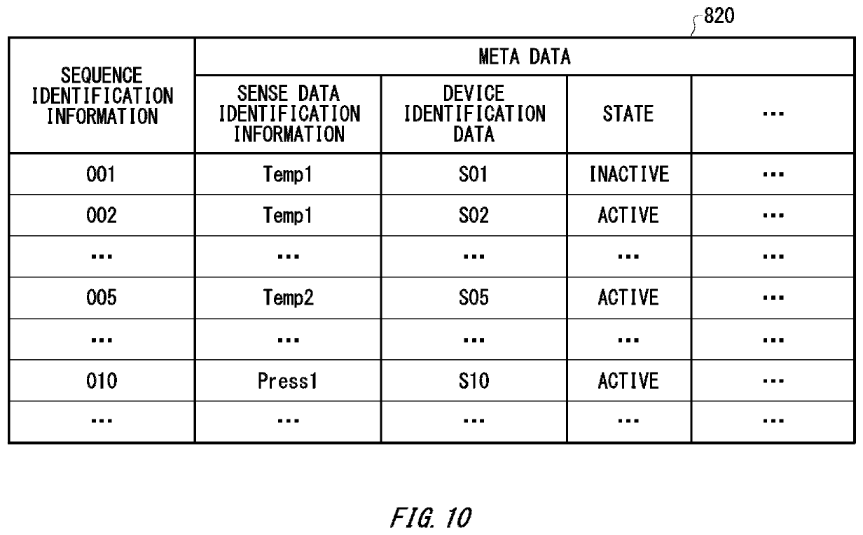

FIG. 10 shows the device management DB 820 according to the present embodiment. The device management DB 820 stores sequence identification information of the sense data, sense data identification information of the sense data, and metadata of the sense data in association with each other. The metadata includes the device identification information of a sensor apparatus 200 and the state information of the sensor apparatus 200. In this way, in the device management DB 820, the sense data identification information is stored in association with each sensor apparatus 200 registered in the base system 160. In FIG. 10, the sense data corresponding to the sequence of the first line and the sense data corresponding to the sequence of the second line are respectively measured by sensor apparatuses 200 before and after replacement, and therefore the respective pieces of device identification information “S01” and “S02” are associated with the same sense data identification information “Temp1”. Furthermore, the state information of the sensor apparatus 200 before replacement shows that this sensor apparatus 200 is inactive, and the state information of the sensor apparatus 200 after replacement shows that this sensor apparatus 200 is active.

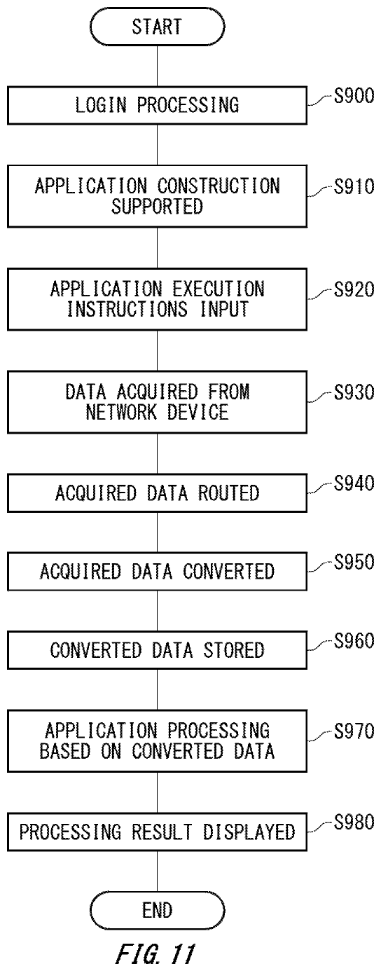

FIG. 11 shows a process flow of the base system 160 according to the present embodiment. At S900, the user login processing section 860 receives the login from the terminal 165 used by the user or the like of the tenant. The user login processing section 860 performs user authentication based on the login ID and the password received from the terminal 165, and performs a login to the account of the tenant corresponding to this login ID in response to successful authentication.

At S910, the application processing section 870 provides the application development environment via the base system 160, and supports the development of the application for the network system by the user of the tenant. For example, the application processing section 870 provides a development environment making it possible to perform selection of each network device 100 used by the application, selection of a data converter 840 used to convert the data from each network device 100, creation and/or recording of logic performing a process and/or control calculation on the data from each network device 100, creation and/or selection of a widget or the like for displaying a processing result of the application in the terminal 165, creation of a display layout of the terminal 165, selection of various templates, and the like.

At S920, the application processing section 870 inputs application execution instructions from the user via the terminal 165. At S930, the device network managing section 800 acquires the data from each of a plurality of network devices 100. For example, the device network managing section 800 may transmit a data read request to each network device 100 with a predesignated period, and gather the data from each network device 100. Instead, each network device 100 may transmit data to the address of the base system 160 registered in the address information storage region 216, with a predetermined period, and the device network managing section 800 may receive the data transmitted from each network device 100. Here, each network device 100 may encrypt the data with a private key possessed by the network device 100 and transmit the encrypted data to the base system 160, and the device network managing section 800 may decrypt the data from each network device 100 with the public key of the corresponding network device 100 to acquire this data. In this way, it is possible to prevent the sense data transmitted by each network device 100 from being intercepted.

At S940, the device router 830 routes the data received from each network device 100 to the data converter 840 to which the corresponding network device 100 has been allocated. At S950, the data converter 840 that has received the data from a network device 100 performs a data conversion corresponding to this data converter 840. Such a data conversion may be converting a temperature data value acquired from a temperature sensor into a data format indicating a temperature in degrees Celsius, or may be converting the data from the network device 100 into any data format demanded by the application executed by the application processing section 870, such as performing any one of smoothing, integration, differentiation, and the like on the sense data from a sensor, for example.

At S960, the data converted by the data converter 840 is stored in the data storage section 850. The data storage section 850 may store the converted data in association with the sense data identification information for each sense data sequence. At S970, the application processing section 870 performs the activation process using the data stored in the data storage section 850, according to an algorithm or the like implemented in the application being executed.

At S980, the application processing section 870 outputs a display screen displaying the application processing result to the terminal 165, and the processing result is displayed to the user of the terminal 165 by the terminal 165. Depending on the content of the application, the application processing section 870 may continuously update the display screen output to the terminal 165, according to the data from each network device 100 that changes over time.

According to the base system 160 shown above, the encryption key for connecting to the network system construction service is distributed to the delivery target network device 100 that is securely installed using the provisioning services of the provisioning system 120 and the provisioning system 140. In this way, the base system 160 can prevent a fraudulent network device 100 from connecting to the network system construction service, and can provide a secure application development and execution environment.

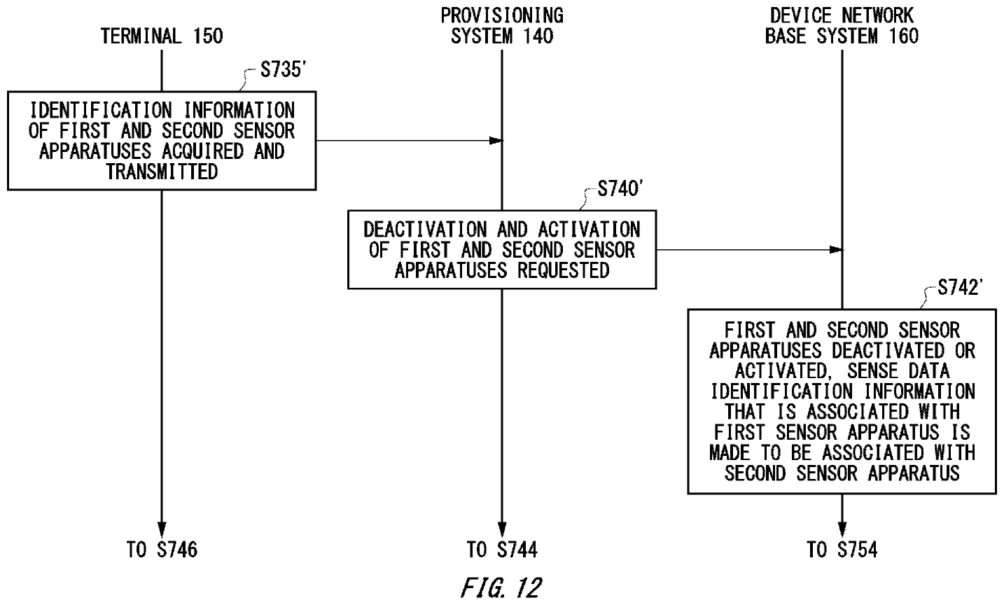

FIG. 12 shows the operational flow of the terminal 150, the provisioning system 140, and the base system 160 in a case where the first sensor apparatus 200 is replaced with the second sensor apparatus 200. This operational flow is performed when the first sensor apparatus 200 is replaced with the second sensor apparatus 200 by a user of the tenant. As an example, this operational flow may be performed after the first sensor apparatus 200 to be replaced is removed from the network 145 and the second sensor apparatus 200 that is the replacement is connected to the network 145 and powered on.

At S735′, the identification information acquiring section 675 in the terminal 150 acquires the device identification information from the body or an accessory of each of the first sensor apparatus 200 and the second sensor apparatus 200 before and after replacement. For example, the identification information acquiring section 675 captures images of the code labels 102 of the first sensor apparatus 200 and the second sensor apparatus 200, and reproduces the encoded device identification information, passcodes, and address information of the provisioning system 140 by recognizing the codes contained in the captured images.

The identification information acquiring section 675 may acquire the device identification information and the like of the first sensor apparatus 200 and the second sensor apparatus 200 with or without distinguishing between the sensor apparatus 200 being replaced and the replacement sensor apparatus 200. Furthermore, the identification information acquiring section 675 may simultaneously capture the image of the code label 102 of the first sensor apparatus 200 and the code label 102 of the second sensor apparatus 200, or may capture one image first and then capture the other. As an example, the identification information acquiring section 675 may capture images of a plurality of code labels 102 together to collectively acquire the device identification information of the first sensor apparatus 200 and the second sensor apparatus 200. Instead, in the display screen of the terminal 150, a message prompting image capturing of the code label 102 of the first sensor apparatus 200 that is being replaced and a message prompting image capturing of the code label 102 of the second sensor apparatus 200 that is the replacement may be sequentially displayed, and the identification information acquiring section 675 may set the device identification information acquired from the code label 102 captured during the display of the former message to be the device identification information of the first sensor apparatus 200 being replaced and set the device identification information acquired from the code label 102 captured during the display of the latter message to be the device identification information of the second sensor apparatus 200 that is the replacement. The identification information acquiring section 675 may acquire only the device identification information from the code label 102 of the first sensor apparatus 200, and does not need to acquire the passcode and the like. The identification information acquiring section 675 may acquire the device identification information of the first sensor apparatus 200 based on an input manipulation to the terminal 150. As an example, a list of active sensor apparatuses 200 that have been registered in the device management DB 820 may be displayed in the display screen of the terminal 150 based on communication performed between the terminal 150 and the provisioning system 140 or the base system 160, and the identification information acquiring section 675 may acquire the device identification information of the sensor apparatus 200 selected by the user as the first sensor apparatus 200 being replaced from the device DB 615 or the device management DB 820. In this way, even if the code label 102 of the first sensor apparatus 200 being replaced is damaged and the device identification information cannot be acquired from image capturing, it is possible to acquire the device identification information of the first sensor apparatus 200 through input manipulation by the user.

The identification information transmitting section 680 in the terminal 150 transmits the device identification information and the like acquired by the identification information acquiring section 675 to the provisioning system 140 designated by the address information acquired by the identification information acquiring section 675. In a case where the identification information acquiring section 675 acquired the device identification information and the like while distinguishing between the first sensor apparatus 200 being replaced and the second sensor apparatus 200 that is the replacement, the identification information transmitting section 680 may transmit the respective pieces of device identification information to the provisioning system 140 while distinguishing between these sensor apparatuses 200. The process of S735′ differs from the process of S735 described above, in that the process of the identification information acquiring section 675 generating the sense data identification information and the identification information transmitting section 680 transmitting this sense data identification information to the provisioning system 140 does not need to be performed. The terminal 150 may move the process to step S746 (see FIG. 7) described above when the process of S735′ is completed.

At S740′, the identification information receiving section 630 in the provisioning system 140 receives the device identification information and the like from the terminal 150. The application processing section 635 in the provisioning system 140 makes a request to the base system 160 for deactivation and activation of the first sensor apparatus 200 and the second sensor apparatus 200 corresponding to the received device identification information. As an example, the application processing section 635 may make a request to the base system 160 to perform deactivation and activation while making a distinction in which one of the first sensor apparatus 200 and the second sensor apparatus 200 is the deactivation target and the other is the activation target. Instead, the application processing section 635 may make a request to specify one piece of device identification information that is already stored in the device DB 615, among the pieces of device identification information received by the identification information receiving section 630, as the device identification information of the first sensor apparatus 200 that has been replaced and to deactivate this first sensor apparatus 200. Furthermore, the application processing section 635 may make a request to specify the other piece of device identification information as the device identification information of the second sensor apparatus 200 that is the replacement, and to activate this second sensor apparatus 200 in the same manner as in S740 described above. When the process of S740′ is completed, the provisioning system 140 may move the process to step S744 (see FIG. 7) described above.

At S742′, the base system 160 receives the request from the provisioning system 140 and performs deactivation and activation of the first sensor apparatus 200 and the second sensor apparatus 200. For example, the device identification information acquiring section 881 of the base system 160 receives the set of device identification information and the like acquired by the terminal 150 from the first sensor apparatus 200 and the second sensor apparatus 200. The state acquiring section 882 of the base system 160 acquires from the device management DB 820 the state information (e.g. information indicating an active state or inactive state) of the sensor apparatus 200 corresponding to each of the two pieces of device identification information. The device specifying section 883 of the base system 160 specifies the device identification information associated with the active sensor apparatus 200, among the two pieces of device identification information acquired by the device identification information acquiring section 881, as the first device identification information of the first sensor apparatus 200 that has been replaced and specifies the device identification information associated with the inactive sensor apparatus 200 (e.g. a sensor apparatus 200 whose state information is not registered) as the second device identification information of the second sensor apparatus 200 that is the replacement. The replacement processing section 880 of the base system 160 then sets the state information of the first sensor apparatus 200 that has been replaced and is associated with the first device identification information in the device management DB 820 to indicate “inactive”, and deactivates the first sensor apparatus 200. The replacement processing section 880 may deactivate the first sensor apparatus 200 by deleting the record of the first sensor apparatus 200 that has been replaced corresponding to the first device identification information in the device management DB 820. Furthermore, the replacement processing section 880 stores the second device identification information and the like of the second sensor apparatus 200 in the device management DB 820 in association with the sense data identification information associated with the first sensor apparatus 200. The replacement processing section 880 sets the state information of the second sensor apparatus 200 that is the replacement associated with the second device identification information in the device management DB 820 to indicate “active”. The replacement processing section 880 stores the first sense data identification information in association with the storage region of the sense data output by the second sensor apparatus 200.

The base system 160 may notify the provisioning system 140 that the device information of the second sensor apparatus 200 has been correctly registered, and move the process to step S754 (see FIG. 7) described above. In a case where the provisioning system 140 has requested deactivation and activation while distinguishing between the first sensor apparatus 200 and the second sensor apparatus 200, the replacement processing section 880 may set the first sensor apparatus 200 to be the deactivation target and the second sensor apparatus 200 to be the activation target. In this case, the replacement processing section 880 does not need to include the state acquiring section 882 and the device specifying section 883.

According to the operations described above, the set of the first device identification information and the second device identification information acquired from the first sensor apparatus 200 and the second sensor apparatus 200 by the terminal 150 is acquired by the base system 160, and therefore it is possible to reliably acquire the sensor apparatus identification information of the sensor apparatuses 200 before and after replacement. Furthermore, the first device identification information and the second device identification information acquired by the image capturing are received from the terminal 150, and therefore it is possible to easily acquire the set of the first device identification information and the second device identification information.

In the embodiments described above, the terminal 150 is described as generating the sense data identification information, but instead the provisioning system 140 or the base system 160 may generate the sense data identification information.

Furthermore, the device identification information acquiring section 881 of the base system 160 is described as acquiring the device identification information and the like recognized from the captured image of the code label 102 by the identification information acquiring section 675 of the terminal 150, but instead the device identification information acquiring section 881 may recognize the device identification information and the like by acquiring the captured image of the code label 102.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include any one of digital and analog hardware circuits and may include any one of integrated circuits (IC) and discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY® disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA®, C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

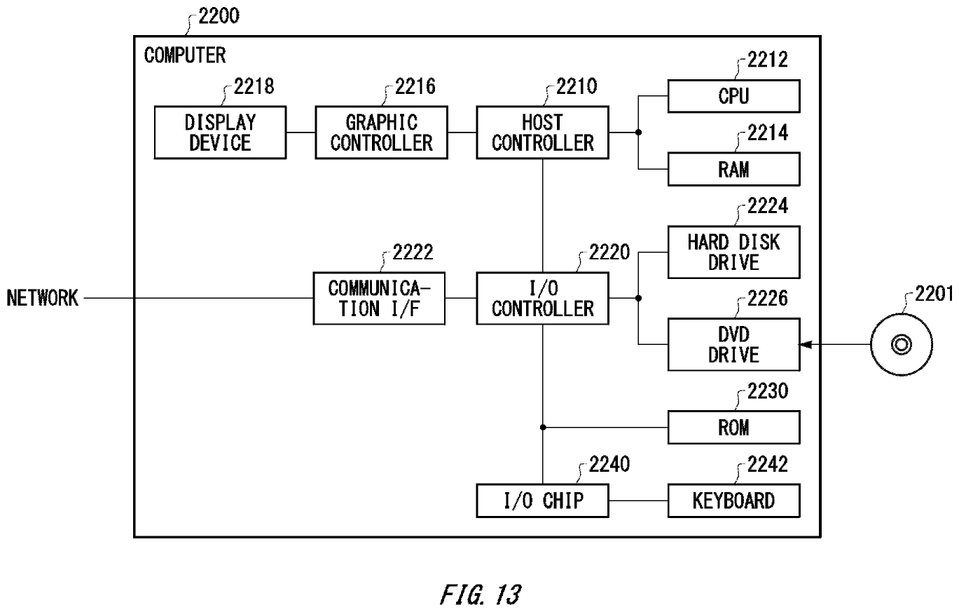

FIG. 13 shows an example of a computer 2200 in which aspects of the present invention may be wholly or partly embodied. A program that is installed in the computer 2200 may cause the computer 2200 to function as or perform operations associated with apparatuses of the embodiments of the present invention or one or more sections thereof, and may cause the computer 2200 to perform processes of the embodiments of the present invention or steps thereof. Such a program may be executed by the CPU 2212 to cause the computer 2200 to perform certain operations associated with some or all of the blocks of flowcharts and block diagrams described herein.

The computer 2200 according to the present embodiment includes a CPU 2212, a RAM 2214, a graphic controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as a ROM 2230 and a keyboard 2242, which are connected to the input/output controller 2220 through an input/output chip 2240.

The CPU 2212 operates according to programs stored in the ROM 2230 and the RAM 2214, thereby controlling each unit. The graphic controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads programs and data from an IC card, and writes programs and data into the IC card.

The ROM 2230 stores therein any one of a boot program or the like executed by the computer 2200 at the time of activation and a program depending on the hardware of the computer 2200. The input/output chip 2240 may also connect various input/output units via a parallel port, a serial port, a keyboard port, a mouse port, and the like to the input/output controller 2220.

A program is provided by computer readable media such as the DVD-ROM 2201 or the IC card. The program is read from the computer readable media, installed into the hard disk drive 2224, RAM 2214, or ROM 2230, which are also examples of computer readable media, and executed by the CPU 2212. The information processing described in these programs is read into the computer 2200, resulting in cooperation between a program and the above-mentioned various types of hardware resources. An apparatus or method may be constituted by realizing the operation or processing of information in accordance with the usage of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, etc., and perform various types of processing on the data on the RAM 2214. The CPU 2212 may then write back the processed data to the external recording medium.

Various types of information, such as various types of programs, data, tables, and databases, may be stored in the recording medium to undergo information processing. The CPU 2212 may perform various types of processing on the data read from the RAM 2214, which includes various types of operations, processing of information, condition judging, conditional branch, unconditional branch, any one of searching for and replacement of information, etc., as described throughout this disclosure and designated by an instruction sequence of programs, and writes the result back to the RAM 2214. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 2200. In addition, a recording medium such as a hard disk or a RAM provided in a server system connected to a dedicated communication network or the Internet can be used as the computer readable media, thereby providing the program to the computer 2200 via the network.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### REFERENCE SIGNS LIST

10: device provisioning environment, 100: network device, 102: code label, 104: identification information storage region, 106: authentication information storage region, 108: encryption key storage region, 120: provisioning system, 125: network, 130: terminal, 135: printer, 140: provisioning system, 145: network, 150: terminal, 160: base system, 165: terminal, 200: sensor apparatus, 210: setting storage section, 212: passcode storage region, 214: address information storage region, 216: address information storage region, 220: sensor, 230: sense data acquiring section, 240: sense data storage section, 250: access control section, 260: network interface, 262: setting storage processing section, 264: device authentication processing section, 266: encryption key receiving section, 268: service connection processing section, 300: sensor gateway apparatus, 320: wired sensor connecting section, 330: wireless sensor connecting section, 340: sense data storage section, 410: setter login processing section, 415: identification information determining section, 420: device DB, 425: authentication information generating section, 430: code generating section, 435: identification information transmitting section, 440: authentication information transmitting section, 445: device registration transmitting section, 450: login processing section, 455: device information acquiring section, 460: device information transmitting section, 465: identification information receiving section, 470: identification information setting section, 475: authentication information receiving section, 480: authentication information setting section, 610: device registration receiving section, 615: device DB, 620: device authenticating section, 625: tenant login processing section, 630: identification information receiving section, 635: application processing section, 640: device registration requesting section, 645: encryption key acquiring section, 650: base address acquiring section, 655: encryption key transmitting section, 660: base address transmitting section, 670: login processing section, 675: identification information acquiring section, 680: identification information transmitting section, 685: activation result notifying section, 800: device network managing section, 805: encryption key issuing section, 810: base address issuing section, 820: device management DB, 830: device router, 840: data converter, 850: data storage section, 860: user login processing section, 870: application processing section, 880: replacement processing section, 881: device identification information acquiring section, 882: state acquiring section, 883: device specifying section, 2200: computer, 2201: DVD-ROM, 2210: host controller, 2212: CPU, 2214: RAM, 2216: graphic controller, 2218: display device, 2220: input/output controller, 2222: communication interface, 2224: hard disk drive, 2226: DVD-ROM drive, 2230: ROM, 2240: input/output chip, 2242: keyboard

What is claimed is:

1. A management device comprising:
a device information storage section that stores sense data identification information identifying sense data output by each of a plurality of sensor apparatuses that communicate via a network, in association with the each sensor apparatus;
a data storage section that stores the sense data received from each of the plurality of sensor apparatuses in association with the sense data identification information associated with the each sensor apparatus in the device information storage section; and
a replacement processing section that, in response to a first sensor apparatus among the plurality of sensor apparatuses being replaced with a second sensor apparatus, sets first sense data identification information associated with the first sensor apparatus in the device information storage section to be second sense data identification information associated with the second sensor apparatus.

2. The management device according to claim 1, wherein
the device information storage section stores device identification information identifying each of the plurality of sensor apparatuses, and
the replacement processing section stores the first sense data identification information associated with first device identification information of the first sensor apparatus that has been replaced, in the device information storage section, in association with second device identification information of the second sensor apparatus that is a replacement.

3. The management device according to claim 2, wherein
the data storage section stores the same sense data identification information and different sequence identification information respectively, in association with the sense data from the first sensor apparatus that has been replaced and the sense data from the second sensor apparatus that is the replacement.

4. The management device according to claim 2, wherein
the replacement processing section includes a device identification information acquiring section that acquires a set of the first device identification information acquired from a body or an accessory of the first sensor apparatus by a terminal and the second device identification information acquired from a body or an accessory of the second sensor apparatus by the terminal.

5. The management device according to claim 4, wherein
the device identification information acquiring section receives from the terminal the first device identification information acquired by the terminal capturing an image of a first code provided by being at least one of affixed to, printed on, and engraved on the body or the accessory of the first sensor apparatus and the second device identification information acquired by the terminal capturing an image of a second code provided by being at least one of affixed to, printed on, and engraved on the body or the accessory of the second sensor apparatus.

6. The management device according to claim 2, wherein
the replacement processing section includes a device identification information acquiring section that acquires a set of the first device identification information and the second device identification information by performing image recognition on an image captured by a terminal, in which a first code provided by being at least one of affixed to, printed on, and engraved on a body or an accessory of the first sensor apparatus and a second code provided by being at least one of affixed to, printed on, and engraved on the body or the accessory of the second sensor apparatus are captured together.

7. The management device according to claim 5, wherein
the device identification information acquiring section acquires a plurality of pieces of device identification information,
the replacement processing section includes:
a state acquiring section that acquires from the device information storage section a state of each sensor apparatus corresponding to a respective piece of device identification information among the plurality of pieces of device identification information; and
a device specifying section that specifies device identification information associated with an active sensor apparatus among the plurality of pieces of device identification information as the first device identification information of the first sensor apparatus that has been replaced, and specifies device identification information associated with an inactive sensor apparatus among the plurality of pieces of device identification information as the second device identification information of the second sensor apparatus that is the replacement.

8. The management device according to claim 5, wherein
the replacement processing section is capable of receiving from the terminal the first device identification information input to the terminal, instead of the first device identification information acquired by the terminal capturing an image of the first code.

9. The management device according to claim 1, further comprising:
a gateway setting section that performs a setting for a gateway, which relays communication between the management device and at least one sensor apparatus among the plurality of sensor apparatuses, that allows the gateway to forward sense data from the second sensor apparatus to the management device.

10. A management method comprising:
storing, in a device information storage region, sense data identification information identifying sense data output by each of a plurality of sensor apparatuses that communicate via a network, in association with the each sensor apparatus;
storing, in a data storage region, the sense data received from each of the plurality of sensor apparatuses in association with the sense data identification information associated with the each sensor apparatus in the device information storage region; and
in response to a first sensor apparatus among the plurality of sensor apparatuses being replaced with a second sensor apparatus, setting first sense data identification information associated with the first sensor apparatus in the device information storage region to be second sense data identification information associated with the second sensor apparatus.

11. A non-transitory computer-readable medium storing thereon a program that, when executed by a computer, causes the computer to perform operations comprising:
storing, in a device information storage region, sense data identification information identifying sense data output by each of a plurality of sensor apparatuses that communicate via a network, in association with the each sensor apparatus;
storing, in a data storage region, the sense data received from each of the plurality of sensor apparatuses in association with the sense data identification information associated with the each sensor apparatus in the device information storage region; and
in response to a first sensor apparatus among the plurality of sensor apparatuses being replaced with a second sensor apparatus, setting first sense data identification information associated with the first sensor apparatus in the device information storage region to be second sense data identification information associated with the second sensor apparatus.
